(19) United States
(12) Patent Application Publication
(10) Pub. No.: US 2018/0289167 A1
(43) Pub. Date: Oct. 11, 2018

(54) Exercise Seat

(71) Applicant: Michael James Tedesco, Greenwich, CT (US)

(72) Inventor: Michael James Tedesco, Greenwich, CT (US)

(21) Appl. No.: 15/947,654

(22) Filed: Apr. 6, 2018

Related U.S. Application Data
(60) Provisional application No. 62/591,841, filed on Nov. 29, 2017.
(60) Provisional application No. 62/582,448, filed on Nov. 7, 2017.
(60) Provisional application No. 62/503,394, filed on May 9, 2017.
(60) Provisional application No. 62/483,412, filed on Apr. 9, 2017.

(51) Int. Cl. A47C 9/00; A47C 9/02; A47C 3/026; A61H 1/00

(52) U.S. Cl. CPC A47C 9/002; A47C 9/02; A61H 2201/1215; A61H 1/005; A61H 2201/0149; A47C 3/026

(57) ABSTRACT

The present invention is an exercise seat comprising a base, a seat, and a movement device comprising a lower platform engaged with the base and an upper platform engaged with the seat. The movement device further comprises a movement mechanism engaged with the lower platform and the upper platform to cause a wobble movement of the upper platform and the seat while maintaining the upper platform and the seat in a stationary position.

### CROSS-REFERENCE TO RELATED APPLICATIONS

This application claims the benefit of and priority to U.S. Provisional Application Ser. No. 62/591,841 filed on Nov. 29, 2017, now pending, which is hereby incorporated into this specification by reference in its entirety. This application further claims the benefit of and priority to U.S. Provisional Application Ser. No. 62/582,448 filed on Nov. 7, 2017, now pending, which is hereby incorporated into this specification by reference in its entirety. This application further claims the benefit of and priority to U.S. Provisional Application Ser. No. 62/503,394 filed on May 9, 2017, now pending, which is hereby incorporated into this specification by reference in its entirety. This application further claims the benefit of and priority to U.S. Provisional Application Ser. No. 62/483,412 filed on Apr. 9, 2017, now pending, which is hereby incorporated into this specification by reference in its entirety.

### BACKGROUND OF THE INVENTION

Since the widespread use of computers, people currently spend most of their workday sitting which is quite different than most historic workday activities. This daytime sitting is in addition to the sitting one does at home or when in other sitting situations like in autos, airplanes, boats, waiting rooms, entertainment events, etc. The health impact from this enhanced sedentary lifestyle has been proven increasingly detrimental, including the stagnation and build up of belly (visceral) fat.

### SUMMARY OF THE INVENTION

One object of the present invention was to design a seat or device that could be easily used while sitting to exercise primarily the abdominal region of a person's body to improve posture and blood circulation.

In one embodiment, the present invention is an exercise seat comprising a base, a seat, and a movement device comprising a lower platform engaged with the base. The movement device further comprises an upper platform engaged with the seat. The movement device further comprises a movement mechanism engaged with the lower platform and the upper platform to cause a wobble movement of the upper platform and the seat while maintaining the upper platform and the seat in a stationary position. In one embodiment, the movement mechanism comprises a shaft comprising a lower portion rotatably engaged with the lower platform and an upper portion rotatably engaged with the upper platform to cause the wobble movement. The lower portion of the shaft comprises a central longitudinal axis. The upper portion of the shaft comprises a central longitudinal axis that is off-set from the longitudinal axis of the lower portion of the shaft. Rotation of the shaft causes the wobble movement of the upper platform and the seat. The exercise seat of the present invention allows a person to sit on the seat and conduct normal activities, such as typing, while being exposed to the wobbling movement and exercise of primarily the abdominal region of the person's body to improve posture and blood circulation. In other embodiments, the movement device may be employed in many other types of seats, including, but not limited to, a chair, stool, physical therapy seat or a truck seat for a commercial truck where the truck driver spends longs hours sitting.

### BRIEF DESCRIPTION OF THE DRAWINGS

The following description of the present invention will be better understood with reference to the accompanying drawings in which:

FIG. 1 is a high level block diagram showing an exercise seat according to the present invention.

FIG. 2 is a perspective view of an exercise seat according to a first embodiment of the present invention showing a movement device with lower and upper platforms and a movement mechanism in the form of a centrally disposed and rotating cam shaft to impart a wobble movement to the upper platform of the movement device and the seat.

FIGS. 3A and 3B are a perspective and an exploded view, respectively, of the movement device of FIG. 2.

FIG. 4A is a side view of the cam shaft.

FIG. 4B is a cross-section view of the cam shaft.

FIG. 5A is a side view of the movement device (without the motor unit, power supply, and springs).

FIG. 5B is a cross-section view of the movement device (without the motor unit, power supply or springs) showing the lower and upper roller bearings disposed within the cam shaft and the upper platform off-set from the lower platform.

FIG. 7 is a perspective view of a movement device comprising a movement mechanism employing a plurality of electro-mechanical actuators to impart a wobble movement to the upper platform and the seat.

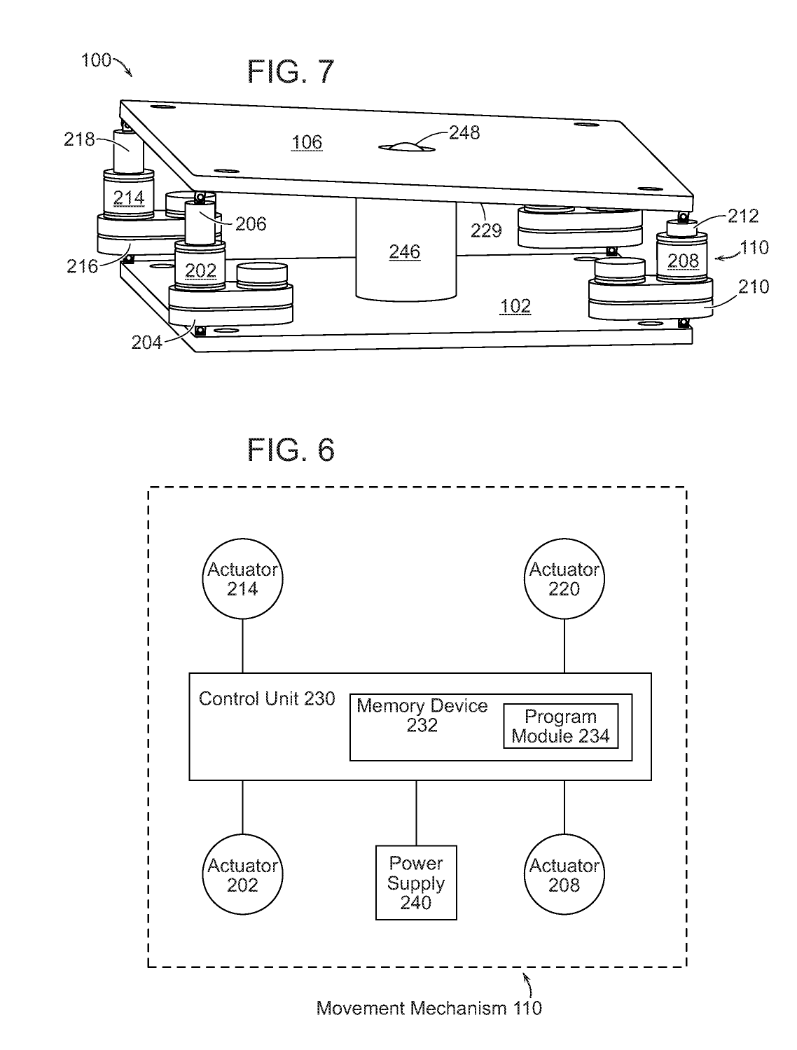

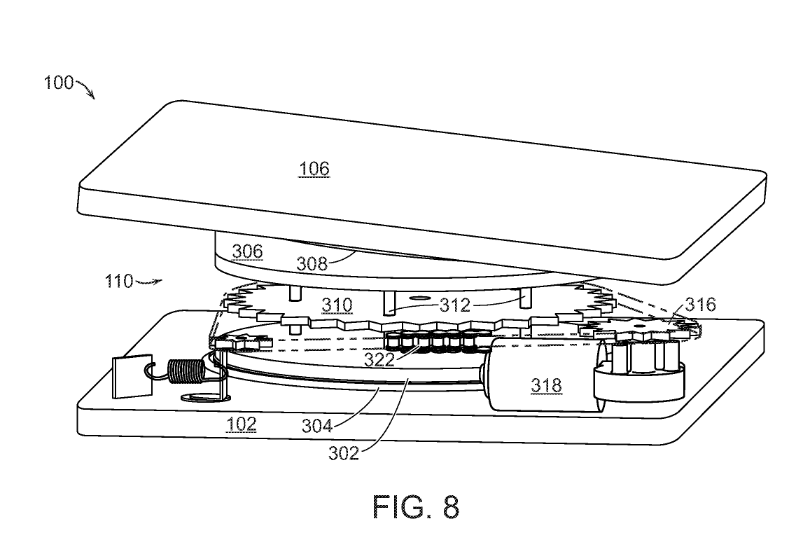

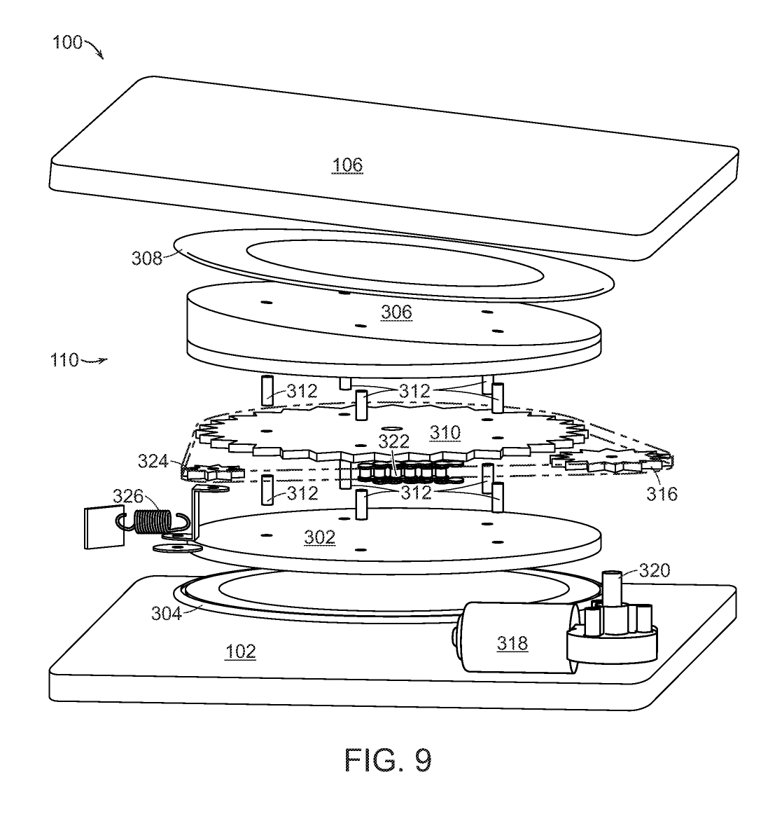

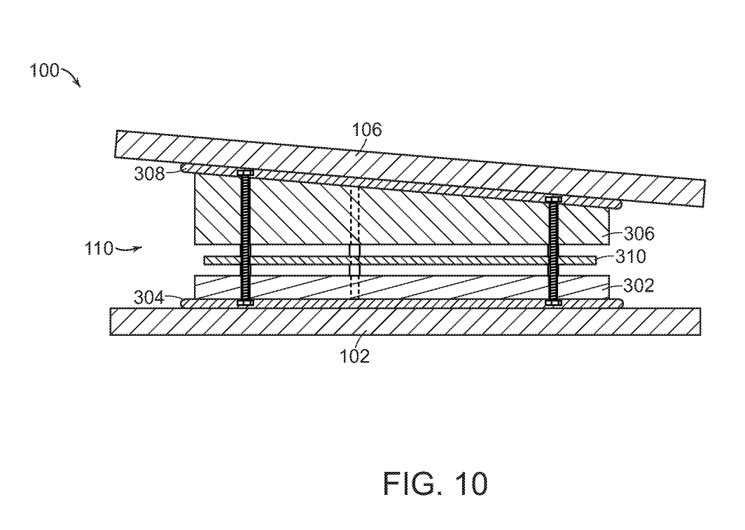

FIG. 6 is a high level block diagram of the movement mechanism of FIG. 7.

FIG. 8 is a perspective view of a movement device comprising a movement mechanism employing a chamfered rotational plate to impart a wobble movement to the upper platform and to any seat attached thereto.

FIG. 9 is an exploded view of the movement device of FIG. 8.

FIG. 10 is a cross-section view the movement device of FIG. 8.

### DESCRIPTION OF THE INVENTION

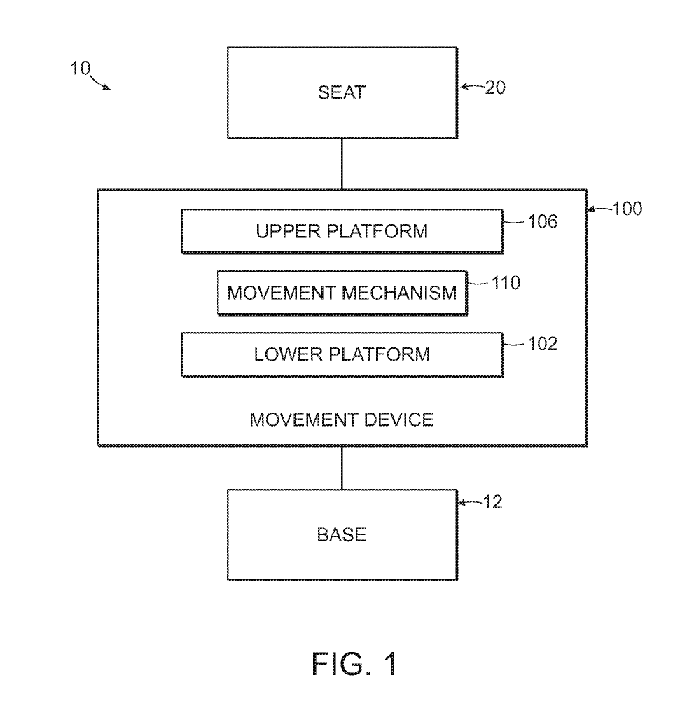

Referring to FIG. 1, where an exercise seat 10 according to the present invention comprises a base 12, a seat 20, and a movement device 100 comprising a lower platform 102 connected with base 12, an upper platform 106 connected with seat 20, and a movement mechanism 110 to cause a wobble movement of upper platform 106 and seat 12 while maintaining upper platform 106 and seat 20 in a stationary position. The term “wobble movement” means an oscillating movement of upper platform 106 about a central axis of lower platform 102 without rotation of upper platform 106 relative to lower platform 106. The term “movement mechanism” means any mechanical and/or electro-mechanical device(s) employed to impart a wobble movement to upper platform 106 relative to lower platform 102 of movement device 100. Exercise seat 10 allows a person to sit on seat 20 and conduct normal activities, such as typing, while being exposed to the wobble movement and exercise primarily the abdominal region of the person's body to improve posture and blood circulation. Many other application of exercise seat 10 are possible. By way of example only, exercise seat 20 may be used by a physical therapist to help a person exercise the abdominal region of the person's body to improve posture and blood circulation or other injuries in that area of the body such as muscular injuries.

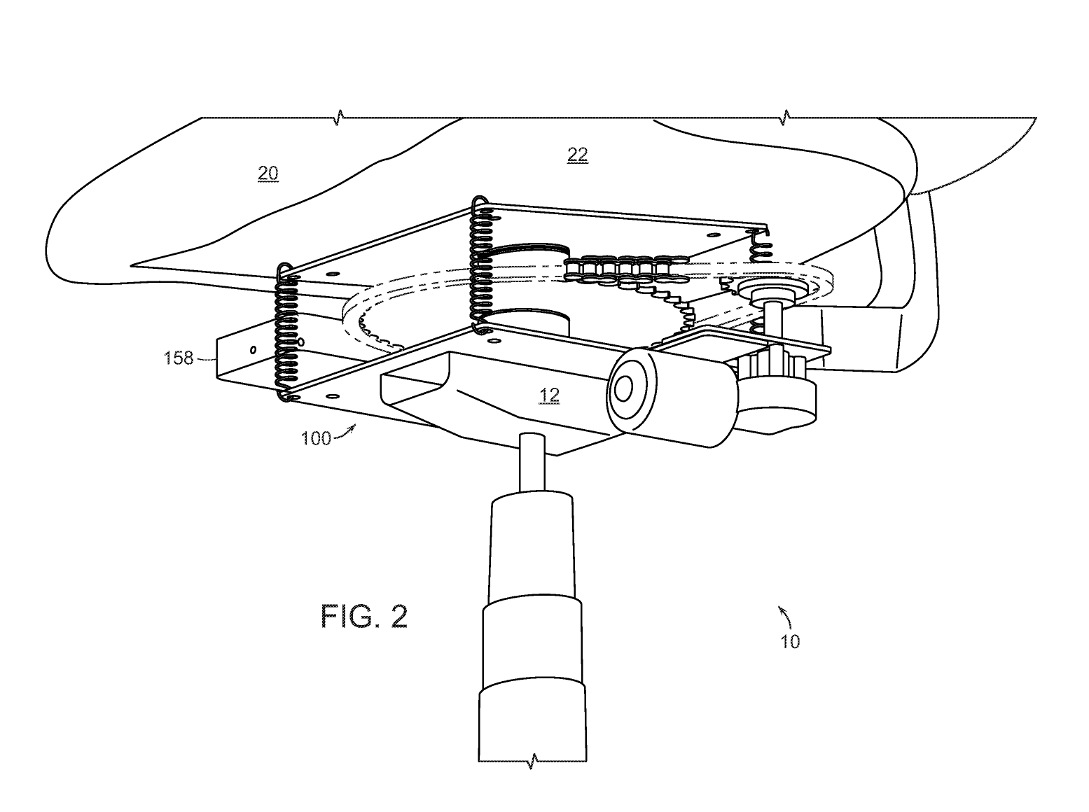

Referring to FIG. 2, where a perspective view shows seat 10 according to the present invention. In this embodiment, lower platform 102 is secured to a mounting bracket 14 of base 14 by conventional means such as bolts and nuts. Upper platform 106 is secured to a bottom portion 22 of seat 20 by conventional means such as screws. Operation of movement mechanism 110 causes a wobble movement of upper platform 106 and seat 20 while maintaining upper platform 106 and seat 20 in a stationary position. In the embodiment shown, lower platform 102 and upper platform 106 are each a substantially planar plate made from steel with a width of fourteen (14) inches and a length of fourteen (14) inches. Lower platform 102 and upper platform 106 may be fabricated by convention processes.

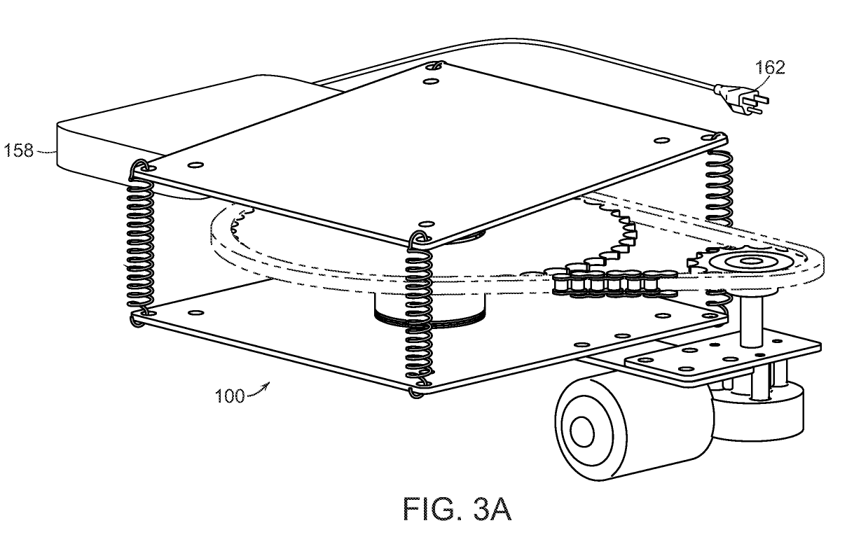

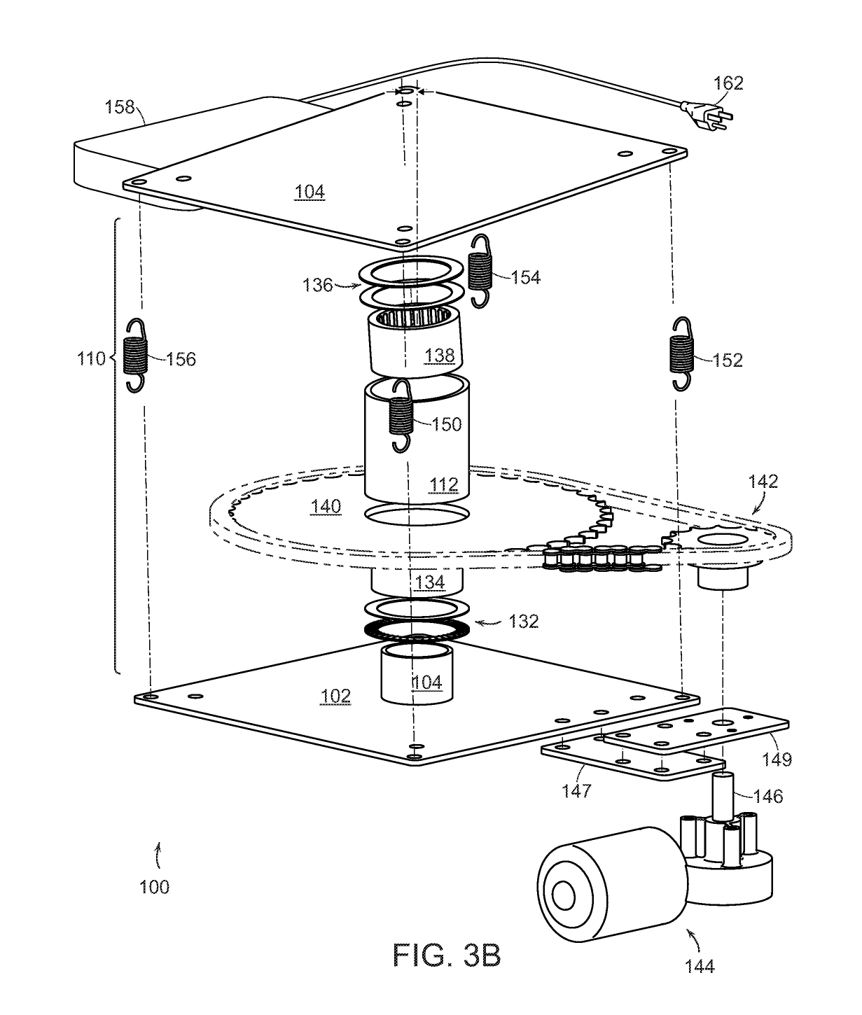

Referring to FIG. 3, where an exploded view shows lower platform 102 and upper platform 106 of movement device 100, and the major components of one type of movement mechanism 110. Lower platform 102 of movement mechanism 110 comprises a boss 104 disposed about a central axis of lower platform 104. Upper platform 106 of movement mechanism 110 comprises a boss 108 disposed about a central axis of upper platform 106. In this embodiment, movement mechanism 110 comprises a cam shaft 112, a lower thrust bearing 132, a lower roller bearing 134, an upper thrust bearing 136, an upper roller bearing 138, a first sprocket 140, a second sprocket 142, a motor unit 144, a sprocket chain 148, and springs 150, 152, 154, and 156. Movement mechanism 110 further comprises a power supply 158.

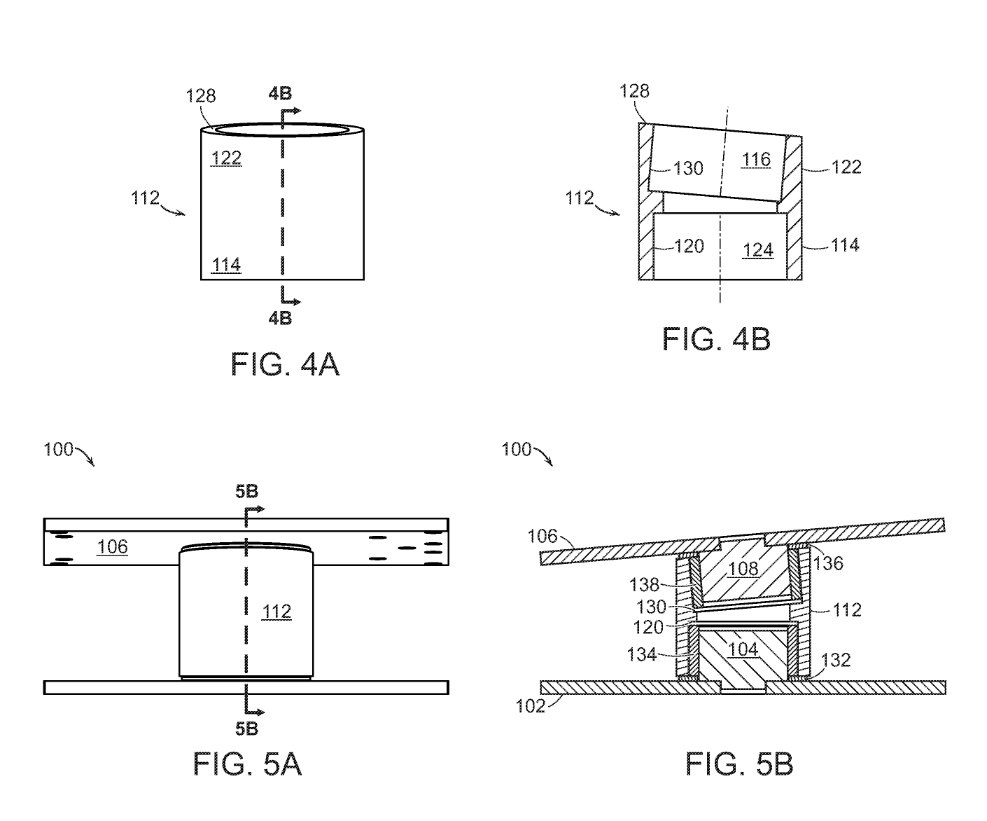

Referring to FIGS. 4A and 4B, cam shaft 112 comprises a lower portion 114 and an upper portion 122. Lower portion 114 of cam shaft 112 is rotatably engaged with lower platform 102. Upper portion 122 of cam shaft 112 comprises an annular bearing surface or end 128 that is rotatably engaged with upper platform 106 to impart a wobble movement to upper platform 106. Lower portion 114 of cam shaft 112 comprises a cylindrical cavity 116 having a central axis 118. Upper portion 122 of cam shaft 112 comprises a cylindrical cavity 124 having a central axis 126 that is off-set from central axis 118 of lower portion 114. In the embodiment shown, it is critical that the off-set be about five (5) degrees or in the range of three (3) degrees to eight (8) degrees to allow a wobble movement in the range of 0.50 and 2.5 inches. An off-set outside this range will cause excessive wobble movement or interference thereby preventing a person from conducting their normal activities. Cavity 116 comprises an annular flange 120 which as will be described more fully herein, is adapted to stop movement of lower roller bearing 134 within cavity 116. Cavity 124 comprises an annular flange 130 which as will be described more fully herein, is adapted to stop movement of a upper roller bearing 138 within cavity 116. Cam shaft 112 may be made from any strong material such as steel and may be fabricated by conventional processes such as casting and machining.

Referring to FIGS. 5A and 5B, where lower roller bearing 134 and upper roller bearing 138 are engaged within lower portion 114 and upper portion 122 of cam shaft 112, respectfully. Lower thrust bearing 132 is engaged with and disposed between lower portion 116 of cam 112 and lower platform 102. Upper thrust bearing 136 is engaged with and disposed between annular bearing surface 128 of upper portion 122 and upper platform 106. Boss 104 of lower platform 102 is disposed within lower roller bearing 134. Boss 108 of lower platform 106 is disposed within upper roller bearing 138. Lower and upper roller bearings 134 and 138 are widely available, for example, Part No. 5905K345 (a steel needle-roller bearing open seal, 1¾″ shaft diameter, 1″ wide) from McMaster-Carr, Street Address 200 New Canton Way, Robbinsville, N.J. 08691-2343 (www.mcmaster.com). Lower and upper thrust bearings 132 and 136 are widely available, for example, as Part No. 5909K42 (needle-roller thrust bearing for 1¾″ shaft diameter, 2½″ OD) from McMaster-Carr, Street Address 200 New Canton Way, Robbinsville, N.J. 08691-2343 (www.mcmaster.com).

Motor unit 144 comprises an output shaft 146 connected to second sprocket 142. First sprocket 140 is secured by conventional means such as welding to lower portion 114 of cam shaft 112. Second sprocket 142 and first sprocket 140 are connected by a sprocket chain 148. Motor unit 144 is electrically connected to power supply 159. Turning on switch 160 of power supply 158 causes second sprocket 142 to rotate which in turn causes rotation of first sprocket 140 and cam shaft 112. The teeth ratio of second sprocket 142 to first sprocket 140 is chosen such that upper platform 106 completes a single wobble cycle, namely, one complete rotation of cam shaft 112, every two (2) to four (4) seconds. Motor unit 144 is widely available, for example, as Part No. PN01007-10038 (⅜″ D Shaft Electric Gear Motor 12 v Low Speed 100 RPM Gear motor DC) from MakerMotor, 7056 Archibald Avenue #102, Corona, Calif. 92880 (www.makermotor.com). First sprocket 140 is widely available, for example, as Part No. 2299K37 (flat sprocket for ANSI 40 Chain, 45 Teeth, for 23/32″ shaft diameter) from McMaster-Carr, 200 New Canton Way, Robbinsville, N.J. 08691-2343 (www.mcmaster.com). Second sprocket 142 is widely available, for example, as Part No. 2737T92 (roller chain sprocket for ANSI 41 Chain, 7 Teeth, for ⅜″ Shaft Diameter) from McMaster-Carr, 200 New Canton Way, Robbinsville, N.J. 08691-2343 (www.mcmaster.com). Sprocket chain 148 is widely available, for example, as Part No. 6261K173 (roller chain, single strand, ANSI Number 40, ½″ Pitch) from McMaster-Carr, 200 New Canton Way, Robbinsville, N.J. 08691-2343 (www.mcmaster.com). In the embodiment shown, power supply 158 is an AC/DC power converter comprising a switch 160 and electrical cord and plug 162. Power supply 158 is widely available, for example, as Part No. PS12V17A (12 v dc regulated switching power Supply 17 A with ON/OFF switch) from MakerMotor, 7056 Archibald Avenue #102, Corona, Calif. 92880 (www.makermotor.com). In other embodiments, power supply 158 may be a twelve (12) volt DC removable and rechargeable power supply or any other presently and/or futurely developed power source, including but not limited to, solar power or compressed air.

Springs 150, 152, 154 and 156 are connected between lower platform 102 and lower platform 106 by hooks to prevent rotation of upper platform 106 when cam shaft 112 rotates. Springs 150, 152, 154 and 156 are widely available as Part No. 9654K303 from McMaster-Carr, Street Address 200 New Canton Way, Robbinsville, N.J. 08691-2343 (steel extension spring with hook ends, music-wire, 2.812″ overall length, 0.75″ OD).

In operation, movement device 100 is turned on by activation of switch 160 causing cam shaft 112 to rotate and impart a wobble movement to upper platform 106 and seat 20. Springs 150, 152, 154 and 156 are connected between lower platform 102 and lower platform 106 by hooks to prevent rotation of upper platform 106 when cam shaft 112 rotates. The person can discontinue the wobble movement by turning switch 160 off.

Referring to FIGS. 6 and 7, where a movement device 100 employing another type of movement mechanism 110 is shown comprising four (4) actuators 202, 204, 206, and 208 secured to lower platform 102 and engaged with upper platform 106 to impart a wobble movement to upper platform 106. Actuators 202, 204, 206, and 208 are placed around lower platform 202 in circular fashion to engage upper platform 106. Movement device 100 further comprises a programmable control unit 210 to vertically lift and retract each of actuators 202, 204, 206, and 208 in orchestrated unity to impart a Wobble Movement to upper platform 106.

With continued reference to FIGS. 6 and 7, actuator 202 comprises a lower portion 204 secured to lower platform 102 and extension rod 206 that move upward and downward as controlled by control unit 210. An end portion 207 of extension rod 206 is engaged with upper platform 106. Actuator 208 comprises a lower portion 210 secured to lower platform 102 and extension rod 212 that move upward and downward as controlled by control unit 210. An end portion 213 of extension rod 212 is engaged with upper platform 106. Actuator 214 comprises a lower portion 216 secured to lower platform 102 and extension rod 218 that move upward and downward as controlled by control unit 210. An end portion 219 of extension rod 212 is engaged with upper platform 106. Actuator 220 comprises a lower portion 222 secured to lower platform 102 and extension rod 224 that move upward and downward as controlled by control unit 210. An end portion 225 of extension rod 212 is engaged with upper platform 106. In the embodiment shown, actuators 202, 204, 206, and 208 are mechanical worm screw type but future actuators may take the form of air, hydraulic or magnetic actuations. Each of actuators 202, 204, 206, and 208 have a weight capacity to lift a minimum of 350 lbs. Actuators 202, 204, 206, and 208 are widely available as linear vertical lift actuators, for example, as Part No. 5-1845-2 (1.96″ Stroke 110 lbs 12 Volt DC Linear Actuator) from Surplus Center (www.surpluscenter.com).

With continued reference to FIGS. 6 and 7, control unit 210 comprises a controller 212, a memory device 214 and a program module 216 stored on memory device 214. Program module 216 comprises computer instructions that cause controller 212 to send output voltages to lift and retract actuators 202, 204, 206, and 208 in orchestrated unity to impart a Wobble Movement to upper platform 106. Movement device 100 further comprises a power supply 212 to provide power to control unit 210. In the embodiment shown, the power supply 212 is an AC to DC transformer that plugs into a standard 120 VAC outlet. Control unit 210 can vary the voltage to actuators 202, 204, 206, and 208 causing upper platform 106 to complete one Wobble Movement at the rate of between two (2) and four (4) seconds. Control unit 210 is widely available, for example as, a microcontroller from Arduino (www.arduino.com). Movement mechanism 110 further comprises a power supply 240 connected with control unit 210. Power supply 240 comprises a switch 242 and an electrical cord & plug 244. Power supply 240 is widely available.

Referring to FIGS. 8-10, where another type of movement mechanism 110 comprises a lower rotational plate 302 rotatably engaged by a ball bearing unit 304 to lower platform 102. Movement device 100 further comprises a chamfered rotational plate 306 rotatably engaged by a ball bearing unit 308 to upper platform 106. Chamfered rotational plate 306 comprises a bearing surface 307 that is in direct rotatable bearing contact with upper platform 106 by ball bearing unit 308. The angle of chamfered rotational plate 306 is about five (5) degrees and defines the amount of wobble movement and is the same angle as provided for the off-set or the angle of annular bearing surface 128 of cam shaft 112 of FIGS. 2-5 described heretofore. Movement mechanism 110 further comprises a central sprocket 310 having five (5) opening 311) disposed about the centerline of lower platform 102. Sprocket 310 is securely engaged with lower rotational plate 302 and chamfered rotational plate 306 by five spacer tubes 312 and five (5) bolts 314 passing there thru and engaged with five (5) nuts, respectively (not shown). Movement mechanism 110 further comprises a motor unit 318 comprising an output shaft 320. Movement mechanism 110 further comprises a drive sprocket 316 engaged with output shaft 320 of motor unit 318. Movement mechanism 110 further comprises a sprocket chain 322 engaging central sprocket 310 and drive sprocket 317 to cause rotation of lower rotational plate 302 and chamfered rotational plate 306. Movement mechanism 110 may further comprise a tension sprocket 324 and a tension spring 326 engaged with sprocket chain 322 to provide steady tension to sprocket chain 322. Movement mechanism 110 further comprises four (4) springs 346 engaged between upper platform 106 and lower platform 102 to prevent rotation of upper platform 106 during rotation of chamfered rotational plate 306. Movement mechanism 110 further comprises a power supply 340 having a on/off switch 342 and an electrical cord & plug 344. Power supply 340 is electrically connected to motor unit 318. Power supply 340 is widely available, for example, as Part No. PS12V17A (12 v dc regulated switching power Supply 17 A with ON/OFF switch) from MakerMotor, 7056 Archibald Avenue #102, Corona, Calif. 92880 (www.makermotor.com). Power supply 340 may be any presently and/or futurely developed of power source, including but not limited to, a battery, solar power or compressed air. Motor unit 318 is widely available, for example, as Part No. PN01007-10038 (⅜″ D Shaft Electric Gear Motor 12 v Low Speed 100 RPM Gear motor DC) from MakerMotor, 7056 Archibald Avenue #102, Corona, Calif. 92880 (www.makermotor.com). Turning on of switch 324 causes rotation of output shaft 320, central sprocket, and chamfered rotational plate 306 thereby imparting a wobble movement to upper platform 106.

Movement device 100 may be employed with various types of seats, including but not limited to a chair, a stool seat, a car seat, a truck seat, or a physical therapy seat. Movement device 100 and movement mechanism 112 may take many forms. By way of example only, the internal movement mechanism 112 may be affixed to a 14×14 inch upper platform and a 14 inch by 14 inch base to cause the upper platform to evenly wobble with no axial deflection at the rate of one wobble for every 5 seconds. The wobble at the edge of the upper platform to the base to be 1″ from top to bottom and can be envisioned as a ½″ deflection from parallel platform to base in both the up and down positions. The maximum dimension from bottom of base to top of platform to be no more than 3½″. The power source actuating the movement mechanism may be a 12 volt DC removable and rechargeable power supply attached to a motor with sufficient gearing to achieve the above mentioned wobble cycle. All electronics and movement mechanism not to exceed any of the overall dimensions of the unit. The center of the platform to be able to hold a maximum weight of 600 pounds and the flat edges to accommodate up to 250 pounds without compromise of performance. The power source to be able to run the unit at maximum weight load for a minimum of 4 hours. The rechargeable batteries must have a charge recovery time of no greater than 1 hour. The movement mechanism may be a 12 volt DC geared motor with a minimum of 10,000 service hours. Even and axially centric wobble movement of the platform to the base. Wobble to be 1″ from top to bottom, or ½″ deflection from parallel platform to base. The desired wobble rate should be one wobble cycle every 5 seconds. The platform must hold up to 600 pounds at center of platform and 250 pounds at straight edges of platform. The power source is a removable and rechargeable 12 volt long life battery(s). Also provided is a mated recharging unit capable of full charge within 1 hour. A power I/O switch should be side mounted. Also a DPDT switch may be provided to enable reverse wobble motion.

While particular embodiments of the invention have been shown and described, it will be obvious to those skilled in the art that changes and modifications may be made without departing from the scope of the claimed invention.

1. A exercise seat comprising:
a base;
a seat; and
a movement device comprising a lower platform engaged with said base; an upper platform engaged with said seat; and a movement mechanism engaged with said lower platform and said upper platform to cause a wobble movement of said upper platform and said seat while maintaining said upper platform and said seat in a stationary position.

2. The seat of claim 1, wherein said movement mechanism comprises a shaft comprising a lower portion rotatably engaged with said lower platform and an upper portion rotatably engaged with said upper platform to cause said wobble movement; said lower portion of said shaft comprising a central longitudinal axis; said upper portion of said shaft comprising a central longitudinal axis off-set from said longitudinal axis of said lower portion of said shaft; rotation of said shaft causing said wobble movement of said upper platform and said seat.

3. The seat of claim 2, wherein said movement mechanism further comprises a first sprocket engaged with said shaft.

4. The seat of claim 3, wherein said movement mechanism further comprises a second sprocket engaged with said first sprocket to rotate said shaft.

5. The seat of claim 4, wherein said movement mechanism further comprises a sprocket chain to engage said second sprocket with said first sprocket.

6. The seat of claim 5, wherein said movement mechanism further comprises a motor unit comprising an output shaft engaged with said second sprocket.

7. The seat of claim 6, wherein said movement mechanism further comprises a plurality of springs engaged with said upper platform and said lower platform to prevent rotation of said upper platform when said shaft is rotated.

8. The seat of claim 7, wherein said movement mechanism further comprises a lower bearing disposed within said lower portion of said shaft.

9. The seat of claim 8, wherein said movement mechanism further comprises an upper bearing disposed within said upper portion of said shaft.

10. The seat of claim 9, wherein said movement mechanism further comprises a lower bearing disposed between said lower portion of said shaft said lower platform.

11. The seat of claim 10, wherein said movement mechanism further comprises an upper bearing disposed between said upper portion of said shaft said upper platform.

12. The seat of claim 11, wherein said movement mechanism further comprises a power supply electrically connected to said motor unit.

13. The seat of claim 12, wherein said power supply comprises an AC/DC power converter.

14. The seat of claim 13, wherein said power supply further comprises a switch to turn on and off said motor unit.

15. The seat of claim 1, wherein said lower platform and said upper platform are substantially planar plates.

16. The seat of claim 15, wherein said plates are made from steel.

17. The seat of claim 1, wherein said movement mechanism comprise a plurality of actuators engaged with said lower platform and said upper platform to impart said wobble movement to said upper platform.

18. The seat of claim 17, further comprising a control unit to control movement of said actuators to impart said wobble movement to said upper platform.

19. The seat of claim 1, wherein said movement mechanism comprises a lower rotational plate and an upper chamfered rotational plate rotatably engaged with said lower platform and said upper platform, respectively, to impart said wobble movement to said upper platform.

20. The seat of claim 19, wherein said movement mechanism further comprises a sprocket engaged with said lower rotational plate and said upper chamfered rotational plate; said movement mechanism further comprises a motor unit comprising an output shaft, a drive sprocket engaged with said output shaft, and a sprocket chain engaging said drive sprocket and said central sprocket to cause rotation of said lower rotational plate and said upper chamfered rotational plate.
